(19) United States
(12) Patent Application Publication
(10) Pub. No.: US 2023/0077626 A1
(43) Pub. Date: Mar. 16, 2023

(54) FASTENER STRUCTURE

(71) Applicant: TING-JUI WANG, New Taipei City (TW)

(72) Inventor: TING-JUI WANG, New Taipei City (TW)

(21) Appl. No.: 17/867,711

(22) Filed: Jul. 19, 2022

(30) Foreign Application Priority Data
Sep. 13, 2021 (TW) 110134015

(51) Int. Cl. F16B 31/02

(52) U.S. Cl. CPC F16B 31/021

(57) ABSTRACT

A fastener structure includes a head, a fastening portion and a twist break portion. The twist break portion is fastened at an object by the fastening portion, or is fastened at another object through the object by the fastening portion. Once the fastening portion is fastened, the twist break portion is twisted and broken. Thus, the fastener structure of the present disclosure is capable of providing a required object with a stable combining effect.

### CROSS-REFERENCE TO RELATED APPLICATION

This non-provisional application claims priority under 35 U.S.C. § 119(a) on Patent Application No(s). 110134015 filed in Taiwan, R.O.C. on Sep. 13, 2021, the entire contents of which are hereby incorporated by reference.

### BACKGROUND OF THE INVENTION

### 1. Field of the Invention

The present disclosure provides a fastener structure, and in particular to a fastener structure capable of providing a required object with a stable combining effect.

### 2. Description of the Related Art

When at least one object is to be coupled, a fixture is usually used for the coupling. However, due to a structural design of the fixture, the combined object may become unstable and even become loose.

### BRIEF SUMMARY OF THE INVENTION

In view of the prior art above, the applicant has developed a fastener structure in the aim of achieving an object of providing a required object with stable combination.

To achieve the above and other objects, the present disclosure provides a fastener structure including a head, a fastening portion and a twist break portion. The twist break portion is twisted so as to be fastened at an object by the fastening portion, and the twist break portion is twisted and broken once the fastening portion is fastened. Alternatively, the twist break portion is twisted so as to be fastened at another object through the object by the fastening portion, and the twist break portion is twisted and broken once the fastening portion is fastened.

The present disclosure further provides a fastener structure including a head, a fastening portion, a twist break portion and a body. The fastening portion is movably combined with the body. The body is connected at an object. The twist break portion is twisted so as to be fastened at another object through the object by the fastening portion, and the twist break portion is twisted and broken once the fastening portion is fastened.

In the above fastener structure, the head can press against the object or the body.

In the above fastener structure, the twist break portion has an operating portion, and the twist break portion is twisted and broken by means of twisting the operating portion using an assembly tool.

In the above fastener structure, a cross section of a junction between the twist break portion and the head is smaller than a cross section of the fastening portion.

In the above fastener structure, once the head presses against the object, the fastening portion is further fastened at another object through the object.

In the above fastener structure, a float is present between the body and the fastening portion, and is used for top-down or left-right movements so as to facilitate fastening of the fastening portion.

In the above fastener structure, the body is pressurized by an external force so as to be expansion connected at the object.

In the above fastener structure, the body has a material storage portion, and the body is pressurized by an external force such that a material of the object enters or flows into the material storage portion.

In the above fastener structure, the body has a weldable surface. The weldable surface is welded to the object, and the object is a printed circuit board.

Regarding the above fastener structure, the fastener structure is picked up by a tool, moved to an assembly position of the object by the tool, and released or set free from the tool, such that the body is placed at the assembly position of the object.

Regarding the above fastener structure, the fastener structure is picked up by a tool, moved to a predetermined height of an assembly position of an object by the tool, and released or set free from the tool, such that the body is placed at the assembly position of the object.

Regarding the above fastener structure, the fastener structure is picked up by a tool, moved to an assembly position of an object by the tool, pressed down by the tool, and released or set free from the tool, such that the body is placed at the assembly position of the object.

Regarding the above fastener structure, the fastener structure is picked up by a tool, moved to an assembly position of an object by the tool, elastically pressed down by the tool, and released or set free from the tool, such that the body is placed at the assembly position of the object.

Regarding the above fastener structure, the fastener structure is picked up by a tool, and moved to an assembly position of an object by the tool. It is sensed by the tool that the fastener structure comes into contact with the object, and the fastener structure is then released or set free from the tool such that the body is placed at the assembly position of the object.

Regarding the above fastener structure, once the fastener structure is picked up by the tool, a comparison device is provided to compare the fastener structure and the assembly position or an assembly distance of the object, and the fastener structure is moved by the tool according to comparison information of the comparison device.

Regarding the above fastener structure, the fastener structure is stored in a carrier, and is picked up by the tool from the carrier for transportation and assembly, wherein the carrier has a cover.

In the fastener structure above, the fastening portion is a thread, an outer fastener, an inner fastener or a column.

In the above fastener structure, a cross section of a junction between the twist break portion and the head can be adjusted so as to adjust a twisting force during fastening of the fastening portion.

In the above fastener structure, the body has an anti-rotation portion, which is used for matching a corresponding anti-rotation portion of the object to perform corresponding anti-rotation.

The above fastener structure further includes an elastic element. One end of the elastic element presses against the head or the fastening portion, and the other end of the elastic element presses against the body.

Regarding the above fastener structure, the fastener structure is formed by means of lathing, forging, injection molding or embedded injection molding.

Regarding the above fastener structure, the fastener structure is made of a metal material or a non-metal material.

In the above fastener structure, the twist break portion is non-circular or polygonal in shape to facilitate being twisted or broken by an assembly tool.

In the above fastener structure, the head is withdrawn or stored in the body before or after the twist break portion is twisted and broken.

In the above fastener structure, an area of the operating portion is greater than the cross section of the junction between the twist break portion and the head.

Thus, the fastener structure of the present disclosure is capable of providing a required object with a stable combining effect.

### BRIEF DESCRIPTION OF THE DRAWINGS

FIG. 1 is a side schematic diagram of a fastener structure according to a first embodiment of the present disclosure.

FIG. 2 is a schematic diagram of a state of use of a fastener structure according to the first embodiment of the present disclosure.

FIG. 3 is a schematic diagram of a state of use of a fastener structure according to a second embodiment of the present disclosure.

FIG. 4 is a schematic diagram of a fastener structure according to a third embodiment of the present disclosure.

FIG. 5 is a schematic diagram of a fastener structure according to a fourth embodiment of the present disclosure.

FIG. 6 is a schematic diagram of different forms of a fastening portion of a fastener structure of the present disclosure.

FIG. 7 is a schematic diagram of a fastener structure according to a fifth embodiment of the present disclosure.

FIG. 8 is a schematic diagram of a state of use of a fastener structure according to a sixth embodiment of the present disclosure.

FIG. 9 is a schematic diagram of a fastener structure according to a seventh embodiment of the present disclosure.

FIG. 10 is a schematic diagram of a fastener structure according to an eighth embodiment of the present disclosure.

FIG. 11 is a schematic diagram of a state of use of a fastener structure according to a ninth embodiment of the present disclosure.

FIG. 12 is a first schematic diagram of an assembly state of a fastener structure of the present disclosure.

FIG. 13 is a second schematic diagram of an assembly state of a fastener structure of the present disclosure.

FIG. 14 is a third schematic diagram of an assembly state of a fastener structure of the present disclosure.

FIG. 15 is a fourth schematic diagram of an assembly state of a fastener structure of the present disclosure.

### DETAILED DESCRIPTION OF THE INVENTION

To facilitate understanding of the object, characteristics and effects of this present disclosure, embodiments together with the attached drawings for the detailed description of the present disclosure are provided.

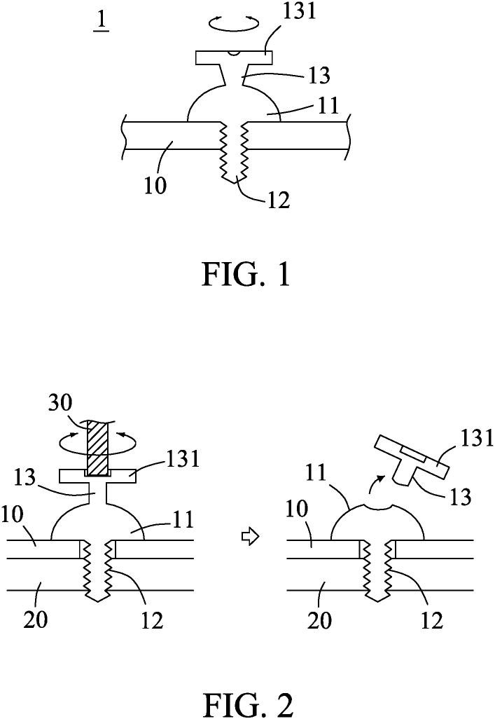

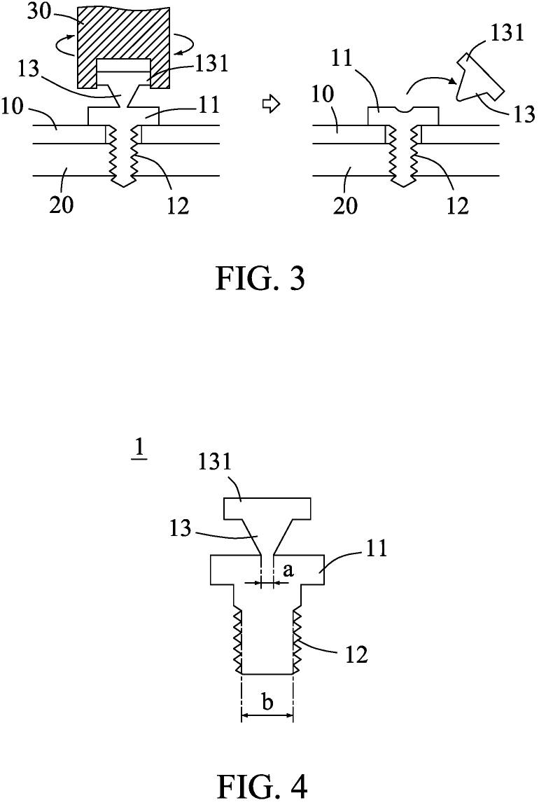

Referring to FIG. 1 to FIG. 3, a fastener structure 1 of the present disclosure includes a head 11, a fastening portion 12 and a twist break portion 13. The twist break portion 13 is twisted so as to be fastened at an object 10 by the fastening portion 12, and the twist break portion 12 is twisted and broken once the fastening portion 12 is fastened (as shown in FIG. 1). Alternatively, the twist break portion 13 is twisted so as to be further fastened at another object 20 through the object 10 by the fastening portion 12, and the twist break portion 13 is twisted and broken once the fastening portion 12 is fastened (as shown in FIG. 2 and FIG. 3).

To put to use, the fastener structure 1 is passed through the object 10 by the fastening portion 12 such that the fastening portion 12 is located at an assembly position of the another object 20, a force is then applied to twist the twist break portion 13, the head 11 is pressed against the object 10, and the fastening portion 12 is further fastened at another object 20 through the object 10 once the head 11 is pressed against the object 10, and the twist break portion 13 is twisted and broken once the fastening portion 12 fastens the object 10 and another object 20, thereby enabling the fastener structure 1 to stably combine the object 10 and another object 20 (as shown in FIG. 2 and FIG. 3).

In one embodiment of the present disclosure, the twist break portion 13 has an operating portion 131. The twist break portion 13 is twisted and broken by means of twisting the operating portion 131 by using an assembly tool 30. The area of the operating portion 131 is greater than a cross section of a junction between the twist break portion 13 and the head 11. Thus, the operating portion 131 is twisted by the assembly tool 30 to allow the fastening portion 12 to be further fastened at another object 20 through the object 10, a force is continually applied on the assembly tool 30 once the fastening portion 12 fastens the object 10 and another object 20, and the twist break portion 13 is twisted and broken through the operating portion 131 by using the assembly tool 30, such that the fastener structure 1 stably combines the object 10 and another object 20 (as shown in FIG. 2 and FIG. 3).

In one embodiment of the present disclosure, the size of the cross section of the junction between the twist break portion 13 and the head 11 can be adjusted so as to adjust a twisting force during fastening of the fastening portion 12. Thus, a twisting force for fastening of the fastening portion 12 can be adjusted in response to different requirements of the object 10 and another object 20, so as to prevent over-twisting and hence preventing the head 11 or the fastening portion 12 from damaging the object 10 and the other object 20.

In one embodiment of the present disclosure, the fastener structure 1 is formed by means of lathing, forging, injection molding or embedded injection molding. Moreover, the fastener structure 1 is made of a metal material or a non-metal material. Thus, different manufacturing processes and materials can be selected for the fastener structure 1 of the present disclosure according to actual requirements or costs.

As shown in FIG. 4, in one embodiment of the present disclosure, a difference from the above embodiment is that, a cross section a of the junction between the twist break portion 13 and the head 11 is smaller than a cross section b of the fastening portion 12. Thus, a twisting force can be continually applied to twist and break the twist break portion 13 once the fastening portion 12 fastens the object 10 and another object 20, such that the fastener structure 1 stably combines the object 10 and another object 20, achieving the effect of easy operability.

In one embodiment of the present disclosure, a twisting force during fastening of the fastening portion 12 can be adjusted by adjusting the size of the cross section of the junction between the twist break portion 13 and the head 11. Thus, a twisting force for fastening of the fastening portion 12 can be adjusted in response to different requirements of the object 10 and another object 20, so as to prevent over-twisting and hence preventing the head 11 or the fastening portion 12 from damaging the object 10 and the other object 20.

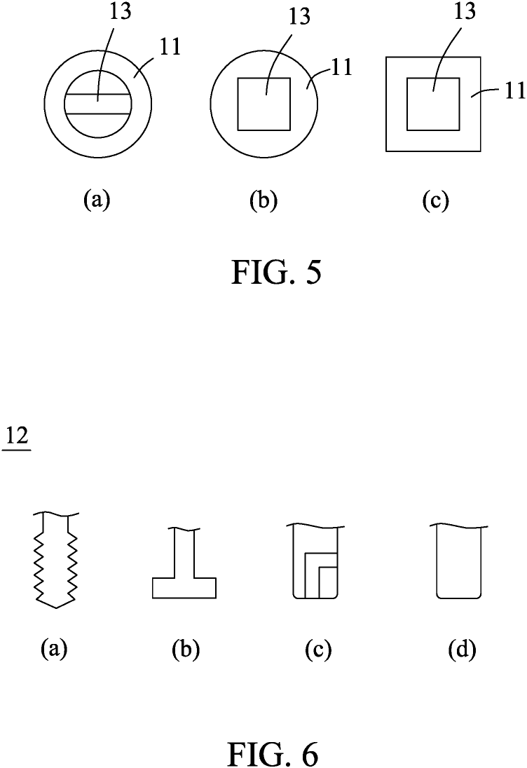

As shown in FIG. 5, in one embodiment of the present disclosure, a difference from the above embodiments is that, the twist break portion 13 is non-circular (part a in FIG. 5) or polygonal (parts b and c in FIG. 5) in shape, so as to be better twisted and broken by the assembly tool 30. Thus, an effect of easy operability can be achieved.

As shown in FIG. 6, in one embodiment of the present disclosure, a difference from the foregoing embodiments is that, the fastening portion 12 can be a thread (as part a in FIG. 6), an outer fastener (as part b in FIG. 6), an inner fastener (as part c in FIG. 6) or a column (as part d in FIG. 6). Thus, the fastening portion 12 can be selected as appropriate in response to different coupling requirements, thereby enabling the present disclosure to better meet actual application requirements.

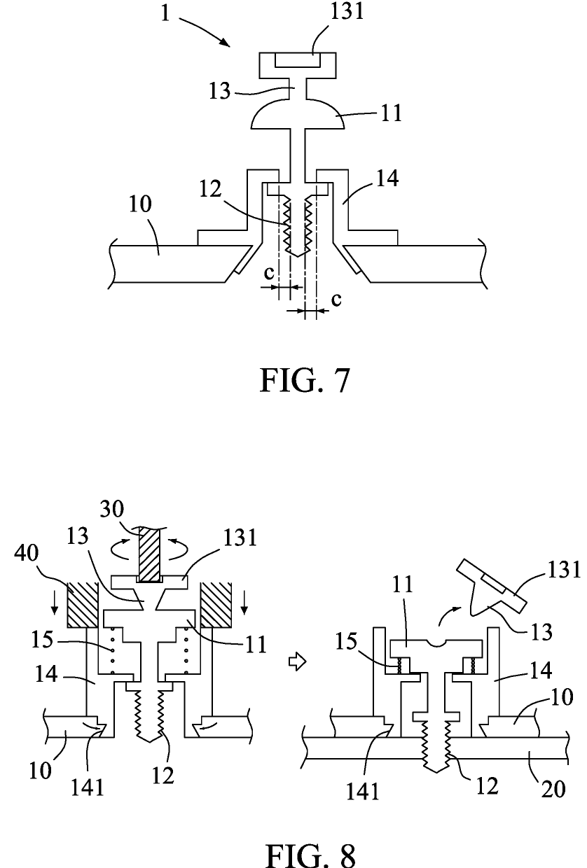

Referring to FIG. 7 and FIG. 8, a fastener structure 1 of the present disclosure includes a head 11, a fastening portion 12, a twist break portion 13 and a body 14. The fastening portion 12 is movably combined with the body 14. The body 14 is connected at the object 10. The twist break portion 13 can be twisted so as to be further fastened at another object 20 through the object 10 by the fastening portion 12 (as shown in FIG. 8), and the twist break portion 13 is twisted and broken once the fastening portion 12 is fastened (alternatively, as in the above embodiments, the twist break portion 13 is twisted and broken to fasten at the object 10 by the fastening portion 12, and the twist break portion 13 is twisted and broken once the fastening portion 12 is fastened, not shown).

In one embodiment of the present disclosure, the head 11 can press against the body 14, and the head 11 is withdrawn or stored in the body 14 before or after the twist break portion 13 is twisted and broken.

In one embodiment of the present disclosure, a float c is present between the body 14 and the fastening portion 12, and is used for top-down or left-right movements so as to facilitate fastening of the fastening portion 12.

To put to use, the body 14 is pressurized by an external force and is expansion connected at the object 10, the fastener structure 1 is passed through the object (not shown) by the fastening portion 12, and the fastening portion 12 is moved in a top-down or left-right manner using the float c such that the fastening portion 12 is located at an assembly position of another object 20. A force is then applied to twist the twist break portion 13, the head 11 is pressed against the object 10, and the fastening portion 12 is further fastened at another object 20 through the object 10 once the head 11 is pressed against the object 10, and the twist break portion 13 is twisted and broken once the fastening portion 12 fastens the object 10 and another object 20, thereby enabling the fastener structure 1 to stably combine the object 10 and another object 20.

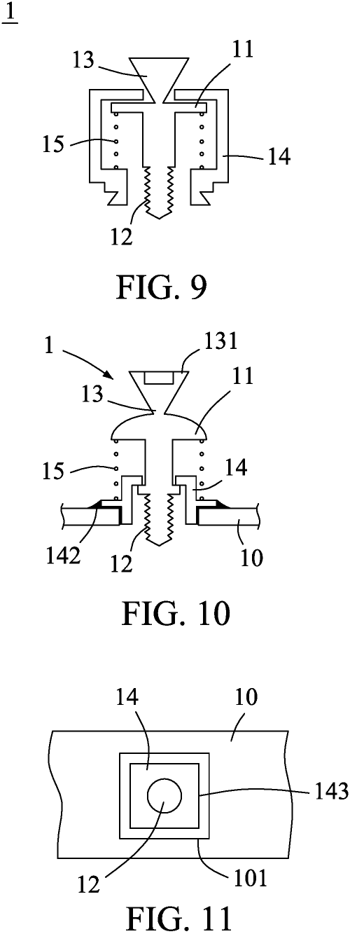

As shown in FIG. 8 to FIG. 10, in one embodiment of the present disclosure, a difference from the above embodiments is that, the body 14 has a material storage portion 141, and the body 14 is pressurized with an external force by a stamping mold 40 to cause the material of the object 10 to enter or flow into the material storage portion 141 (as shown in FIG. 8 and FIG. 9), so that the body 14 is stably combined with the object 10 to facilitate the subsequent operations of head 11 and the fastening portion 12.

In one embodiment of the present disclosure, an elastic element 15 is further included. One end of the elastic element 15 presses against the head 11 (or the fastening portion 12), and the other end of the elastic element 15 presses against the body 14. Thus, with pressing of the elastic member 15, the fastening portion 12 is located at a predetermined height during fastening to facilitate implementation of assembly.

In one embodiment of the present disclosure, a difference from the above embodiments is that, the body 14 has a weldable surface 142. The weldable surface 142 is welded at the object 10, and the object 10 is a printed circuit board (as shown in FIG. 1), so that the body 14 is stably combined with the object 10 to facilitate the subsequent operations of head 11 and the fastening portion 12.

Referring to FIG. 11, in one embodiment of the present disclosure, a difference from the above embodiments is that, the body 14 has an anti-rotation portion 143. The anti-rotation portion 143 is used to match a corresponding anti-rotation portion 101 of the object 10 to perform corresponding anti-rotation, so that the body 14 is stably combined with the object 10 to facilitate the subsequent operations of head 11 and the fastening portion 12.

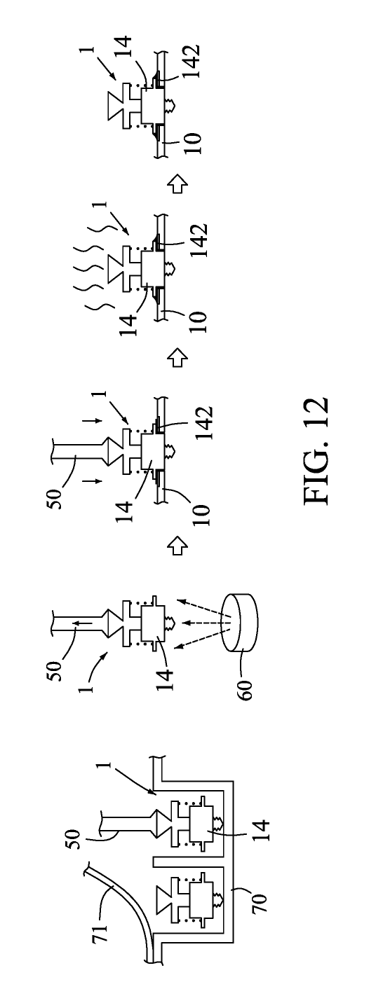

Referring to FIG. 12, in one embodiment of the present disclosure, the fastener structure 1 is picked up by a tool 50 during assembly, moved to an assembly position of the object 10 by the tool 50, released or set free from the tool 50 such that the body 14 is placed at the assembly position of the object 10, and is welded to the object 10 through the weldable surface 142, so that the body 14 is stably combined with the object 10.

In one embodiment of the present disclosure, once the fastener structure 1 is picked up by the tool 50, a comparison device 60 is provided to compare the fastener structure 1 and the assembly position or an assembly distance of the object 10, and the fastener structure 1 is moved by the tool 50 according to comparison information of the comparison device 60, thereby enabling the present disclosure to better meet actual assembly requirements.

In one embodiment of the present disclosure, the fastener structure 1 can be picked up by the tool 50 from a carrier 70, wherein the carrier 70 is provided with a cover 71 according to requirements so as to seal the fastener structure 1 in the carrier 70.

In one embodiment of the present disclosure, the tool 50 is a vacuum suction device, a fixture, a magnetic device, a clamp or a mechanical arm, thereby enabling the present disclosure to better meet actual application requirements.

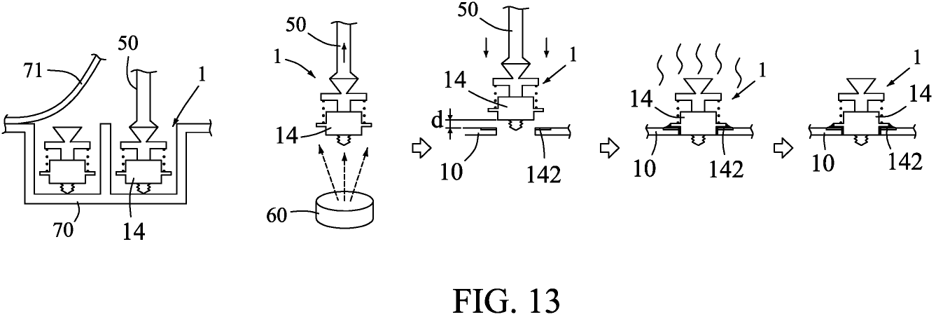

Referring to FIG. 13, in one embodiment of the present disclosure, a difference from the above assembly means is that, the fastener structure 1 is picked up from the carrier 70 by the tool 50 during assembly, the fastener structure 1 and the assembly position or an assembly distance of the object 10 are compared by the comparison device 60, and the fastener structure 1 is moved by the tool 50 according to the comparison information of the comparison device 60. Then, the fastener structure 1 is moved to a predetermined height d of the assembly position of the object 10 by the tool 50, released or set free from the tool 50 such that the body 14 is placed at the assembly position of the object 10, and is welded to the object 10 through the weldable surface 142, so that the body 14 is stably combined with the object 10.

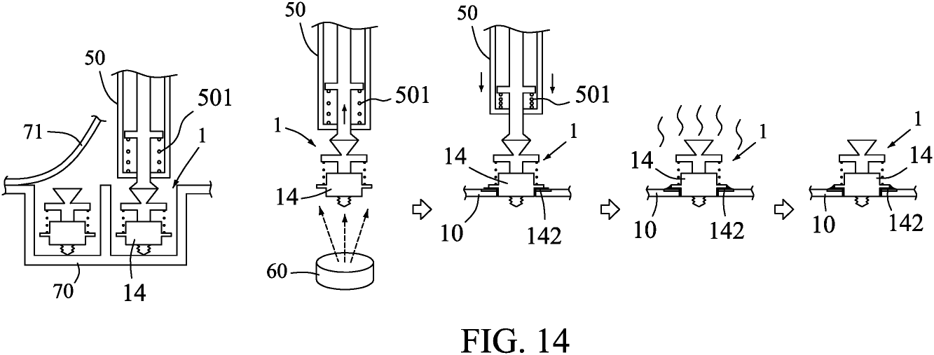

Referring to FIG. 14, in one embodiment of the present disclosure, a difference from the above assembly means is that, the fastener structure 1 is picked up from the carrier 70 by the tool 50 during assembly, moved to an assembly position of the object 10 by the tool 50 according to the comparison information of the comparison device 60, pressed down by the tool 50, released or set free from the tool 50 such that the body 14 is placed at the assembly position of the object 10, and is welded to the object 10 through the weldable surface 142, so that the body 14 is stably combined with the object 10.

Referring to FIG. 14, in one embodiment of the present disclosure, a difference from the above assembly means is that, the fastener structure 1 is picked up from the carrier 70 by the tool 50 during assembly, moved to the assembly position of the object 10 by the tool 50 according to the comparison information of the comparison device 60, elastically pressed down by an elastic device 501 of the tool 50, released or set free from the tool 50 such that the body 14 is placed at the assembly position of the object 10, and is welded to the object 10 through the weldable surface 142, so that the body 14 is stably combined with the object 10.

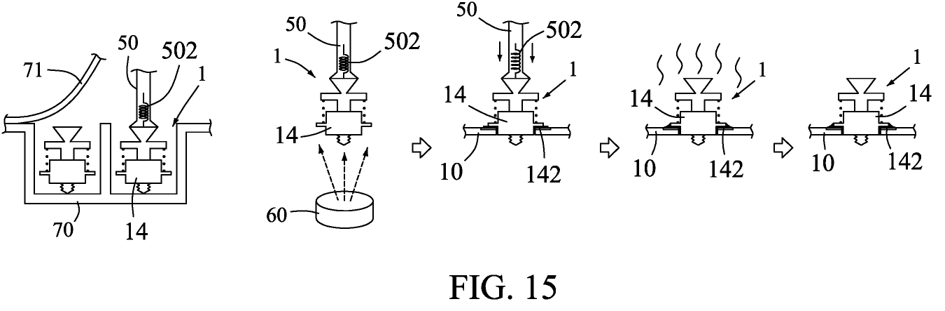

Referring to FIG. 15, in one embodiment of the present disclosure, a difference from the above assembly means is that, the fastener structure 1 is picked up from the carrier 70 by the tool 50 during assembly, and moved to an assembly position of the object 10 by the tool 50 according to the comparison information of the comparison device 60, and it is sensed by a sensor 502 of the tool 50 that the fastener structure 1 comes into contact with the object 10. Then, the fastener structure 1 is released or set free from the tool 50 such that the body 14 is placed at the assembly position of the object 10, and is welded to the object 10 through the weldable surface 142, so that the body 14 is stably combined with the object 10.

The present disclosure is described by way of the preferred embodiments above. A person skilled in the art should understand that, these embodiments are merely for describing the present disclosure are not to be construed as limitations to the scope of the present disclosure. It should be noted that all equivalent changes, replacements and substitutions made to the embodiments are to be encompassed within the scope of the present disclosure. Therefore, the scope of protection of the present disclosure should be accorded with the broadest interpretation of the appended claims.

What is claimed is:

1. A fastener structure, comprising a head, a fastening portion and a twist break portion; wherein, the twist break portion is twisted so as to be fastened at an object by the fastening portion, and the twist break portion is twisted and broken once the fastening portion is fastened; alternatively, the twist break portion is twisted to further fasten at another object through the object by the fastening portion, and the twist break portion is twisted and broken once the fastening portion is fastened.

2. The fastener structure according to claim 1, further comprising a body; wherein, the fastening portion is movably combined with the body, the body is connected at the object, the twist break portion is twisted to fasten at another object through the object by the fastening portion, and the twist break portion is twisted and broken once the fastening portion is fastened.

3. The fastener structure according to claim 2, wherein the head presses against the object or the body, or the fastening portion further fastens at another object through the object once the head presses against the object.

4. The fastener structure according to claim 1, wherein the twist break portion has an operating portion, and the twist break portion is twisted and broken by means of twisting the operating portion using an assembly tool.

5. The fastener structure according to claim 1, wherein a cross section of a junction between the twist break portion and the head is smaller than a cross section of the fastening portion.

6. The fastener structure according to claim 2, wherein a float is present between the body and the fastening portion, and is used for top-down or left-right movements so as to facilitate fastening of the fastening portion.

7. The fastener structure according to claim 2, wherein the body is pressurized by an external force so as to be expansion connected at the object.

8. The fastener structure according to claim 2, wherein the body has a material storage portion, and the body is pressurized by an external force such that a material of the object enters or flows into the material storage portion.

9. The fastener structure according to claim 2, wherein the fastener structure is picked up by a tool, moved to an assembly position of the object by the tool, and released or set free from the tool, such that the body is placed at the assembly position of the object.

10. The fastener structure according to claim 2, wherein the fastener structure is picked up by a tool, moved to a predetermined height of an assembly position of the object by the tool, and released or set free from the tool, such that the body is placed at the assembly position of the object.

11. The fastener structure according to claim 2, wherein the fastener structure is picked up by a tool, moved to an assembly position of an object by the tool, pressed down by the tool, and released or set free from the tool, such that the body is placed at the assembly position of the object.

12. The fastener structure according to claim 2, wherein the fastener structure is picked up by a tool, moved to an assembly position of an object by the tool, elastically pressed down by the tool, and released or set free from the tool, such that the body is placed at the assembly position of the object.

13. The fastener structure according to claim 2, wherein the fastener structure is picked up by a tool and moved to an assembly position of an object by the tool, it is then sensed by the tool that the fastener structure comes into contact with the object, and the fastener structure is released or set free from the tool such that the body is placed at the assembly position of the object.

14. The fastener structure according to claim 2, wherein the body has an anti-rotation portion, which is used for matching a corresponding anti-rotation portion of the object to perform corresponding anti-rotation.

15. The fastener structure according to claim 2, further comprising an elastic element, wherein one end of the elastic element presses against the head or the fastening portion, and one other end of the elastic element presses against the body.

16. The fastener structure according to claim 2, wherein the head is withdrawn or stored in the body before or after the twist break portion is twisted and broken.

17. The fastener structure according to claim 1, wherein the twist break portion has an operating portion, and an area of the operating portion is greater than a cross section of a junction between the twist break portion and the head.
